(19) United States
(12) Patent Application Publication
(10) Pub. No.: US 2021/0146219 A1
(43) Pub. Date: May 20, 2021

(54) SYSTEM AND METHOD FOR COLLECTING AND PROCESSING DATA ASSOCIATED WITH PLAYERS PLAYING A BALL GAME

(71) Applicant: SPORTBAK, Bouc Bel Air (FR)

(72) Inventors: Benjamin SIMEONI, Bouc Bel Air (FR); Gabriel COHEN, Bouc Bel Air (FR)

(73) Assignee: SPORTBAK, Bouc Bel Air (FR)

(21) Appl. No.: 16/624,082

(22) PCT Filed: Jun. 18, 2018
(86) PCT No.: PCT/FR2018/000175

§ 371 Date: Jan. 28, 2020

(30) Foreign Application Priority Data
Jun. 20, 2017 (FR) 17 00663

(51) Int. Cl. A63B 71/06; A43B 3/00; A43B 5/02; A63B 43/00; A63B 69/00; A63B 24/00

(52) U.S. Cl. CPC A63B 71/0605; A43B 3/0005; A43B 5/02; A63B 41/00; A63B 69/002; A63B 24/0021; A63B 43/004

(57) ABSTRACT

The invention relates to a system for collecting and processing data associated with players playing a ball game, where the ball comprises at least one RFID transmitter in the form of a passive RFID tag. For every player, an active RFID radio frequency sensor is worn on every limb authorized to come into contact with the ball, said RFID sensor being able to measure the instantaneous distance between the RFID sensor and the RFID transmitter from the strength of the radio frequency signal received from the RFID transmitter. An accelerometer measures the instantaneous acceleration of said limb. A microprocessor and a memory are used for time-stamping and storing the measurements output by the RFID sensor and the accelerometer for the purpose of post-processing. A central processing unit runs a program configured to read and process the data recorded in the memory units worn by the players and to deduce therefrom data representative of certain physical or technical information related to the play of the players.

The present invention relates to a collection system and to a method for processing data associated with players playing a ball game, for example, within the context of playing soccer.

### PRIOR ART

Several systems are already known in the prior art for monitoring parameters representing the physical and technical activity of sportspeople, in particular in the field of team-based ball games.

In the field of professional team sports, systems exist for monitoring the physical and technical parameters of the players that are based on image processing technology.

They involve the use of cameras and of image processing software, as well as human intervention to eliminate any computer errors.

Systems also exist for autonomous video analyses, without human intervention. The aim of these systems is also to quantify the physical and technical activity of the sportsperson. However, the number and the type of events that are captured is then limited. Finally, these systems have to contend with genuine reliability problems when several people participate in a playing event.

Overall, the known systems are very complex and very expensive and are outside the scope of most sports, in particular amateur sports.

A system is also known, from document US 2011/304487 A1, for collecting and processing data associated with players using a ball, wherein the ball is fitted with an electronic circuit provided with an antenna, and each player also wears a radiofrequency circuit (RF) capable of sending an RF scanning signal to the ball and of receiving an RF signal in response at a frequency that differs from the frequency of the scanning signal, and the circuit worn by the player is configured to compute, on the basis of the difference in frequency between the transmitted signal and the received signal, an approximation of the instantaneous distance between the player and the ball.

This known system has several disadvantages. The use of the phase-shift between the scanning signal results in complex and longer computations. This leads to an excessively low recording speed of the distance between the player and the ball, which is detrimental to the responsiveness of the system. Furthermore, the received signal can be degraded when the ball is moving relatively quickly relative to the foot of the player. These problems are enhanced when the system follows several players at the same time. This results in a limitation both qualitatively (some playing statistics become unavailable) and quantitatively (a significant amount of useful information can be lost).

### AIMS OF THE INVENTION

A general aim of the invention is to propose a new device and a new method for acquiring and processing physical or technical data associated with playing team-based ball sports, which are able to overcome the disadvantages of the known systems.

A particular aim of the invention is to propose a simple system implementing a reliable operating method that is non-intrusive and is inexpensive, allowing physical and technical data to be gathered from soccer, in particular indoor soccer, players and teams, particularly in the amateur world in which the systems must have a limited cost.

Another aim of the invention is to propose a simple to implement system and method, able to provide a greater amount of physical and/or technical data that is more precise than that which is obtained in the prior art, whilst being able to be used by the greatest majority of people.

Another aim of the invention is to propose a highly responsive system and method, allowing a time of detection of the presence of the ball within a 50 cm radius in less than 50 ms, in order to be able to capture all the playing events up to a ball speed reaching 80 km/h.

### SUMMARY OF THE INVENTION

In principle, all the events related to running a football match are recorded by virtue of the interaction between the sensors of the system. These interactions are then paired with time data, which will allow the events to be rewritten according to their order of completion.

Unlike the systems of the prior art that use the phase-shift between the transmission and the reception of an RF scanning signal, the invention is based on the use of the received strength value, denoted RSSI (Received Signal Strength Indication), to determine the distance between the players and the ball as a function of time. The RSSI is then used again to chronologically classify playing sequences and to deduce therefrom a set of statistics corresponding to playing situations.

Therefore, the aim of the invention is a system for collecting and processing data associated with players playing a ball game, wherein the ball comprises at least one RFID transmitter in the form of a passive radiofrequency tag, characterized in that it comprises:
for each player, an active RFID radiofrequency sensor worn on every limb allowed to come into contact with the ball, said RFID sensor being able to measure, on the basis of the strength (RSSI) of the radiofrequency signal received from the RFID transmitter, the instantaneous distance between said RFID sensor and said RFID transmitter, and an accelerometer able to measure the instantaneous acceleration of said limb, as well as a microprocessor and a memory for time-stamping and storing the measurements originating from the RFID sensor and the accelerometer for the purpose of post-processing; and
a central processing unit provided with a program configured to read and process the data recorded in the memory units worn by the players and to deduce therefrom data representing certain physical or technical information related to the play of the players.

According to an advantageous embodiment, each RFID sensor is configured to transmit a periodic radio signal for detecting the RFID tag of the ball, for periodically determining the RSSI value and for associating therewith a time-stamp of the detection.

In a version optimized for the game of indoor soccer, allowing real-time analysis of the game, the system according to the invention comprises an anklet for each foot of the players, each anklet integrating an RFID sensor and an accelerometer, and each sensor is provided with an identification number associated with a single player.

A further aim of the invention is a method for processing data recorded by the system as described above, so as to generate playing statistics for the different players, characterized in that it comprises a step involving deducing, from the absolute value of each RSSI strength value recorded by an RFID sensor, the instantaneous distance between this RFID sensor of a player and the ball, said absolute value of the RSSI strength being lower the nearer the ball is to the RFID sensor of said player.

The method comprises a step involving recording each detected RSSI strength value that is less than a predefined threshold value RSSIₘₐₓ, as well as the time-stamp of its detection.

The method also preferably comprises a step involving recording, at regular intervals, the values originating from the accelerometers worn by each player, as well as the time-stamp corresponding to each recording and the identification (ID) of the player corresponding to each recording.

At the end of the match time, or during the match for indoor soccer, the data (identification ID, recording time-stamp, RSSI value) of the RFID sensors of all the players and the data (identification ID, recording time, acceleration triplet on 3 axes X, Y, Z) of the accelerometers of all the players is collated and sorted in chronological order with a view to post-processing for identifying playing events and determining playing statistics.

In particular, the method comprises a step involving determining, on the basis of the values (identification ID, recording time, RSSI value) originating from the RFID sensors, a playing event involving keeping the ball at a given instant, with the keeper of the ball being defined as being the player whose absolute value of the RSSI strength is the lowest at this instant.

Preferably, the method comprises a step involving determining, on the basis of the action of keeping the ball, a playing event involving the possession of the ball, with the possessor of the ball during a period being defined as being the player keeping the ball at several successive time-stamps of the data originating from the RFID sensors.

On the basis of the ball possession information, a ball loss statistic is defined for each player, incremented each time that the readings of the RSSI value show that the possession of the ball has passed to a player on the opposing team.

Furthermore, on the basis of the ball possession information, a ball recovery statistic is defined for a given player, incremented each time that the readings of the RSSI value show that the possession of the ball has passed from a player on the opposing team to said given player.

The method according to the invention comprises a step involving identifying a shot taken by a player, when, at the end of a period of possession of the ball by a player, the RSSI strength as an absolute value indicated by the RFID sensor of this player is strictly increasing (meaning that the ball is moving away from the player), without the RSSI value of the RFID sensors of the other players indicating that another player has taken possession of the ball.

The method according to the invention further comprises a step 1 able to distinguish a shot by a player and a pass, involving measuring the elapsed time between the last time of a playing period when the player still has possession of the ball, and the time of the start of the action, and (i) if the observed duration is less than a predetermined threshold corresponding to the duration of a shot, then it involves a shot, and (ii) if the observed duration is greater than a predetermined threshold corresponding to the duration of a pass, then it involves a pass, and (iii) if the elapsed time is within the shot duration threshold and the pass duration threshold, the data of the accelerometers allows the action to be identified, with an action with an acceleration that is greater than a predetermined average value corresponding to a shot, and an action with an acceleration that is less than a predetermined average value corresponding to a pass.

The method according to the invention further comprises a step involving identifying a successful pass by a player when, at the end of a period of possession of the ball by a player, the RSSI values show that, at the time following said playing period, the possession of the ball has passed to another player on the same team.

Advantageously, the method according to the invention comprises a step involving identifying an unsuccessful pass by a player when, at the end of a period of possession of the ball by a player, the RSSI values show that, at the time following said playing period, the possession of the ball has passed to a player on the opposing team.

Other statistics can be obtained by virtue of the invention using the same system and the same method.

### DETAILED DESCRIPTION

The invention will now be described in further detail by virtue of the accompanying figures, within the context of an application to the game of soccer, in particular to indoor soccer, with it being understood that adaptation to other ball games such as basketball, volleyball, handball, does not pose a particular technical problem and forms an integral part of the present invention, in which figures:

FIG. 1 is a diagram schematically showing the components of the system according to the invention;

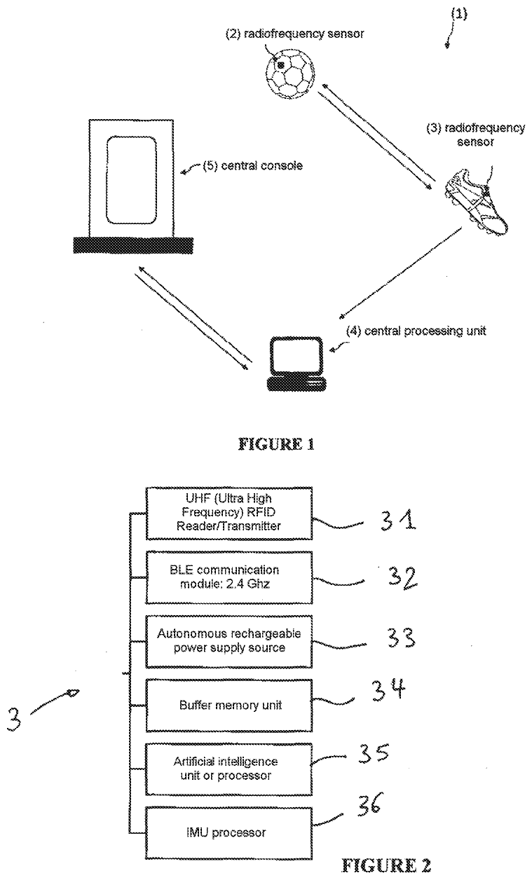

FIG. 2 is a diagram showing the main components of an autonomous radiofrequency sensor of the system of FIG. 1;

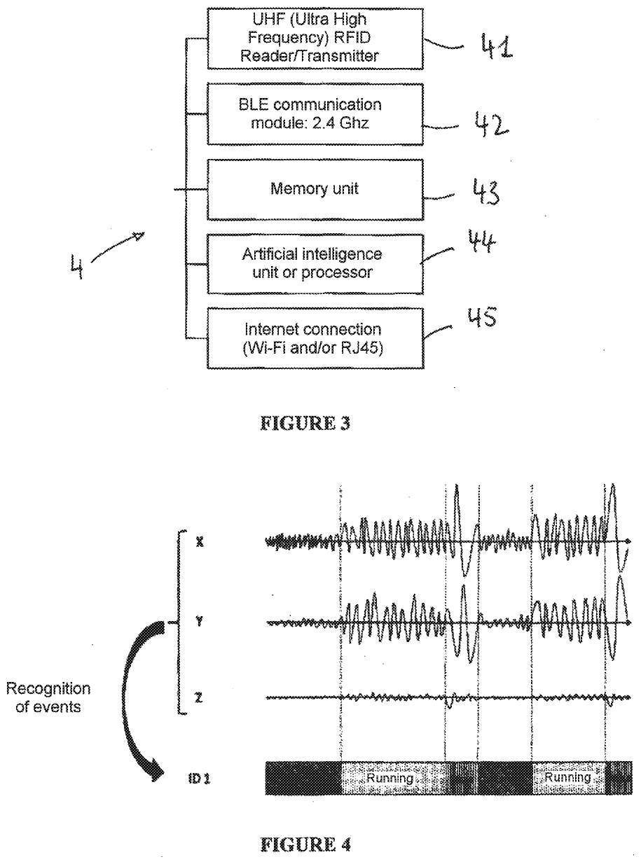

FIG. 3 is a diagram showing the main components of the central processing unit of the system of FIG. 1;

FIG. 4 is a graph of the signal delivered by an accelerometer of the system of FIG. 1;

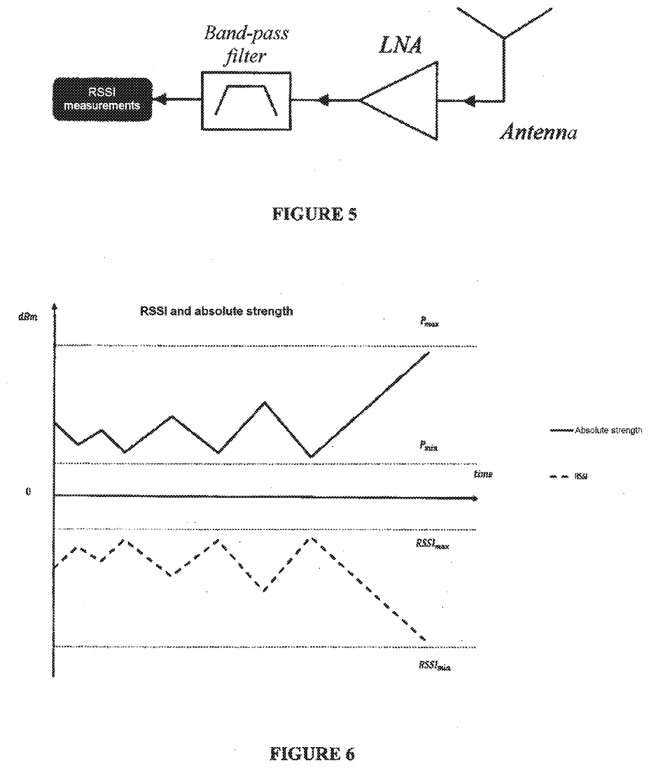

FIG. 5 is a diagram of the acquisition chain of an RFID sensor allowing the RSSI strength value to be measured for a player;

FIG. 6 is a graph of the RSSI strength value as a function of time;

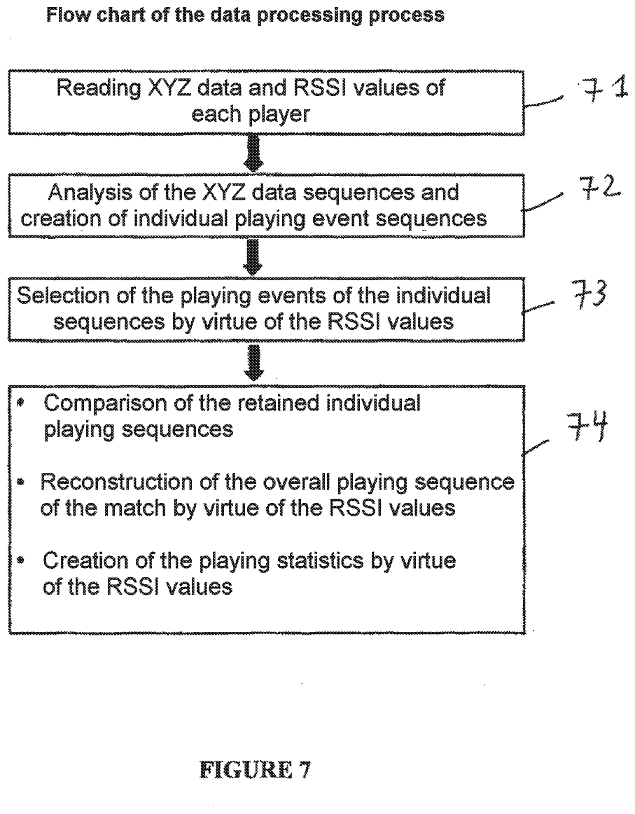

FIG. 7 is a flow chart of the method implemented by the system of FIG. 1;

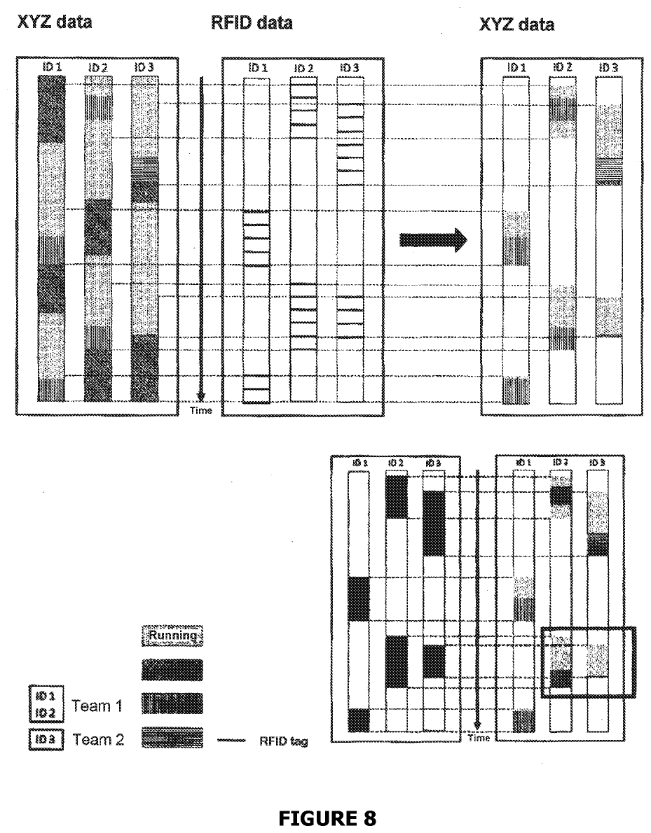

FIG. 8 is a diagram showing, by way of an example, the gathering of data from the RFID sensor and of data from the accelerometer for three players.

As is schematically shown in FIG. 1, the players are equipped with an autonomous radiofrequency sensor (3) comprising one or more active RFID sensors transmitting a radiofrequency signal and one or more accelerometers. The radiofrequency sensors (3) are disposed, for example, in the shoes or in anklets worn by the players. Each RFID sensor and each accelerometer of a sensor (3) has a specific identification number (ID) corresponding to the player and allowing the players to be differentiated from one another.

The ball is equipped with a radiofrequency sensor (2), made up of one or more RF tags, and comprising a miniaturized antenna allowing radiofrequency communication with the radiofrequency sensors (3) of the players. The radiofrequency sensors (2) are preferably passive for the sake of bulk and of cost, but powered active sensors could be contemplated if they are in a small enough format to be integrated in the ball.

FIG. 2 shows the structure of a radiofrequency sensor (3) positioned on a player. This type of sensor is per se known. It comprises:
an RFID reader/transmitter (31) operating at high frequency, for example, at UHF between 865 and 960 MHz;
a BLE communication module (32) in the 2.4 GHz band allowing communication with the central processing unit (4);
a memory unit (43) for storing data originating from the RFID sensors (3);
an autonomous rechargeable power supply source;
a memory unit (34) for storing the data;
a processor (35) provided with a program memory running the processing algorithm and completing local pre-processing in order to streamline the final processing process implemented by the central processing unit (4);
an IMU system (36), which is a system integrating an accelerometer, a gyroscope, as well as a magnetometer. Said magnetometer integrates algorithms for smoothing data and granting access to stable values over time.

FIG. 3 shows the structure of the central processing unit (4) of the system (1). It is connected to a display console (5) (FIG. 1).

The central processing unit (4) basically comprises:
a UHF reader/transmitter (41) for radiofrequency communication with the RFID sensors (3);
a BLE communication module (42);
a memory unit (43) for storing data originating from the RFID sensors and the accelerometers;
a processor (44) for implementing the processing method according to the invention;
an electric power supply source (not shown);
as well as an Internet connection (Wi-Fi or RJ45) allowing a database to be incremented in real-time, for example, a cloud-based database.

The method implemented by the system is mainly based on the combined analysis of the data gathered by the RFID sensors and by the accelerometers worn by the players.

The data from the RFID sensors, and mainly the received strength value (RSSI), is essential with respect to the computation of the technical statistics of the players (for example, the number of passes, shots, etc.), as will be described hereafter.

The data from the accelerometers is, by contrast, essential with respect to the computation of the physical statistics of the players (for example, the distance travelled, etc.).

### Use of the Accelerometers

The data from the accelerometers located on the sensors (3) worn by the players is automatically read at a given frequency, for example, 30 Hz, independently of whether or not the sensor is in the zone of the ball. The accelerometers provide information on 3 axes X, Y, Z, as shown in FIG. 4. A filtering step may be required to eliminate the noise present in the series of X, Y, Z data.

From this point, as is schematically shown in FIG. 4, a simple algorithm based on the analysis of the amplitude of the acceleration on each axis allows the different modes of activity of the player to be identified as a function of time. For example, a low amplitude acceleration signal corresponds to a walking phase, a signal with a greater amplitude and a higher frequency corresponds to a running phase, and a high amplitude signal over a short period corresponds to a passing or shooting phase. This information allows first-order statistics to be constructed relating to the activity of the players, with and without the ball.

In order to identify these different playing phases or events, it is possible to implement curve recognition, through a comparison with indicators previously stored in a characterization phase.

For example, the running, walking, passing, shooting type playing events can be previously characterized on the basis of 8 reference indicators (6 indicators originating from the time domain of the X, Y, Z data, and 2 originating from the frequency domain). These indicators are computed on the X, Y, Z series, as well as on the component of magnitude \sqrt{X²+Y²+Z²}.

In order to obtain quality that is good enough for the characterization of these playing events, the data from the accelerometers of at least 15 different players is preferably used.

The identification of the new data gathered after the characterization phase occurs by browsing through each series of accelerometer data, and by computing the predefined indicators on a sliding window, for example, with a 50% overlap from one window to the next.

The identification is then completed by associating the data on the X, Y, Z axes originating from the accelerometers with the reference indicators, which makes it possible, for each playing sequence of a player, to determine whether they are walking, running, making a pass or a shot. The recognition algorithm involves, for example, minimizing the quadratic norm between the gathered data and the reference indicators.

By way of an example, as shown in FIG. 4, on completion of this step applied to the player ID1, the series of accelerometer data of this player are divided, as a function of time, into running, walking, shooting or passing events.

### Use of the RFID Sensors to Compute the RSSI

In telecommunications, the RSSI is a measurement of the reception strength of a signal received from an antenna. Its purpose is to provide an indication with respect to the intensity of the received signal. Thus, the signal is often measured on the basis of a negative strength scale that is generally expressed in a logarithmic scale (often in dBm).

FIG. 5 is a simplified diagram of the architecture of an RF receiver. The signal received by the antenna is first amplified using a low noise amplifier (LNA), then it is filtered by a band-pass filter in order to measure the received strength (RSSI) at the operating frequency.

Under these conditions, it is possible to show that the distance d between the RFID sensor worn by a player and the tag positioned on the ball is connected to the RSSI by the following formula (1):

$$d = {\frac{λ}{4 π} [ \frac{{P}_{T} {G}_{A}^{2}}{RSSI} ]}^{\frac{1}{4}} , \qquad ( 1 )$$

where:
d represents the distance between the reader and the tag;
P_{T} is the transmission strength;
G_{A} is the gain of the antenna of the RFID sensor.

As the magnitudes G_{A} and P_{T} are continuous, it is possible to compute the distance d between the RFID reader (on the ankle of the player) and the RFID tag (on the soccer ball) at each instant using the formula (1).

In practice, the data from the RFID sensors is read at a frequency of 25 Hz, that is one reading every 50 ms, in order to obtain sufficient responsiveness for the system. Furthermore, the data from the RFID sensors is only read when the RFID sensors are communicating with one or more tags of the ball, in other words when at least one player is near the ball.

As is schematically shown in FIG. 6, the received strength value RSSI is a negative value, and the closer the read strength value is to 0, the closer the player is to the ball. In order to be able to more easily understand the correlation between the RSSI value and the distance between the ball and a limb of the player wearing the RFID sensor, it is worthwhile considering the received strength as an absolute value.

It is to be noted that a signal reflected by the tag (2) of the ball can be accepted by the RFID reader or sensor if, and only if, as an absolute value, the RSSI(t) value is less than a limit value RSSIₘₐₓ dependent on the RFID reader, and corresponding to a maximum distance for detecting the ball by the RFID sensor.

According to the method of the invention, when the ball is located in the transmission zone of an RFID sensor (3) worn by a player, this RFID sensor makes a recording. A recording comprises three data items: an identification number corresponding to the associated player, a precise recording time (a time-stamp), and a received strength value (RSSI).

Within the scope of the invention, the received strength value (RSSI) corresponds to the transmission strength that is required for the RFID sensor (3) worn by the player to be able to communicate between the radiofrequency sensor (2) of the ball and the RFID sensor (3) of the player at a given distance. The further the RFID sensor is from the ball, the greater the required strength. Therefore, there is a direct connection between the RSSI value and the distance between the RFID sensor of the player and the ball, as expressed in the above formula (1).

Consequently, the successive values of RSSI are recorded in a memory unit (34) of each RFID sensor, in order to be able to subsequently deduce therefrom the successive distances between the ball and a player near the ball.

According to one aspect of the invention, playing events are subsequently deduced on the basis of these successive distances.

However, when the ball is not in the transmission zone of the RFID sensor (3) of a player, no recording is made by the RFID sensor.

### Consolidation of all the Data

According to the invention, the data from the RFID sensors and from the accelerometers of each player is collected and stored throughout the entire match time. At the end of the match time, each player has therefore acquired two types of data in the memory units (34) of their sensors: the data originating from their one or more RFID sensors (ID, recording times, successive RSSI values) and the data originating from their one or more accelerometers (ID, recording times, successive values of the X, Y, Z triplet).

At the end of this collection phase, i.e. at the end of the match, the data from all the players is collated and sorted by time in ascending order. Two sets of data are thus obtained that are timed and sorted in chronological order: the data originating from all the RFID sensors of all the players and the data from all the accelerometers of all the players.

It is to be noted that, in a more complex version of the system according to the invention allowing real-time collection of the data, it would be possible to upload all the data in real-time to a remote processing station, in particular within the context of the system being installed in a hall for playing indoor soccer.

In addition to the previously described system and the method for collecting data originating from the sensors (3), a further aim of the invention is the method for processing said data. The ultimate purpose of this phase is to reconstruct the entire playing sequence that unfolded during the match, in order to define a certain number of playing events, then to compute individual or collective statistics based on these playing events.

The steps of the processing method are schematically shown in FIG. 7.

In a first step 71, the system (1) reads, using accelerometers and RFID sensors of the players, the acceleration data on 3 axes X, Y, Z, and the RSSI strength data. This data is stored and time-stamped in the respective sensors (3).

At the end of the match (or in real-time if the system has a real-time transmission architecture, which is per se known), in the step 72, the acceleration and RSSI strength data is reconstituted and sorted as a function of their time-stamp, which allows a succession of playing events to be created. The data originating from the accelerometers is analyzed in order to detect first-order playing events: running, walking, shooting, passing.

In step 73, the playing events are analyzed and sorted as a function of the associated RSSI strength, so as to only keep the useful playing events for each player, namely those that have an RSSI value below a predetermined threshold, i.e. those from events in which the player is in the immediate vicinity of the ball.

In step 74, the method compares the retained individual playing sequences, then reconstructs the overall playing sequence corresponding to the match, by virtue of the RSSI values. By virtue of this comparison, it is then possible to define and to increment a series of individual or collective second-order statistics, for example: a tackle between two players, successful for one and unsuccessful for the other, a successful or unsuccessful dribble, a successful or unsuccessful pass, a recovered or lost ball, interception of the ball, possession of the ball.

Finally, the method ends with the computation and the incrementation of individual or collective playing statistics, by virtue of RSSI strength values and the acceleration values.

An example of this processing is schematically shown in FIG. 8 for a playing sequence involving 3 players denoted ID1, ID2, ID3, with ID1 and ID2 belonging to the same team.

In the top left-hand side of FIG. 8, the activities of each player are shown as a function of time based on their accelerometer reading, as explained with reference to FIG. 4. For example, the player ID1 successively transitions from a walking phase, then a running phase, a pass, a new walking phase, a new running phase, and finally a pass.

The top center of the figure shows, for each player, using a horizontal line, the presence of an RFID reading provided with an RSSI value below the threshold RSSIₘₐₓ, indicating that at these instants the player was near the ball.

The top right-hand side of the figure shows the result of the comparison between the sequences of individual play of each of the 3 players, which will allow second-order statistics to be computed and the playing sequence of the match to be fully reconstructed. The events that correspond to a succession of instants where a player is near the ball form time intervals (shaded parts) that correspond to playing events involving a player and the ball. It is useful for the playing statistics to be derived on the basis of these playing events, by again using the data originating from the accelerometers, if necessary.

For example, if the playing event that is boxed in the bottom right-hand side of FIG. 8 is analyzed, the succession of a running event by ID2, followed by a pass by ID2, can be seen, whilst for the player ID3 the succession of a running event, followed by a very short walking event occurs.

The player ID2 makes a pass at the end of the sequence, which a priori assumes that they were in possession of the ball beforehand. However, at the same time, the RFID reading of the RSSI value indicates that the player ID3 is also in the zone of the ball before this passing event. There are therefore two players around the ball.

In order to precisely determine the possession of the ball, the algorithm again uses the RSSI values by analyzing which player is nearest the ball during this playing phase.

In this precise case, assuming that the RSSI values indicate that the player ID2 was nearer the ball, this effectively confirms that it was definitely them in possession of the ball before the pass.

Ultimately, in this case the playing analysis is as follows:
the player ID2 has possession of the ball (incrementation of the “ball possession” statistic of ID2), the player ID3 comes to contest this possession. There is a tackle (incrementation of the “tackle” statistic). The player ID2 makes a pass (incrementation of the “pass” statistic of ID2), which means that the player ID2 has been successful in their tackle (incrementation of the “successful tackle” statistic of ID2), whereas the player ID3 has been unsuccessful in their tackle (incrementation of the “unsuccessful tackle” statistic of ID3).

The reconstitution of the entire playing sequence will allow a set of individual or collective statistics to be determined, such as the number of passes, shots, tackles won or lost, as will be described hereafter.

It is to be noted that, at each reading time of the RFID sensor, a plurality of data items originating from different players can be present. Indeed, it is possible that at the same reading time, several players were near the ball and that an RFID reading was taken at the same time for several players. Therefore, it is necessary to determine which player from among those near the ball was in possession of the ball.

According to the invention, the comparison, as a function of their time-stamp, of the RSSI data originating from the RFID sensors allows the ball possession to be determined. The ball possession is computed on the basis of the ball keeper statistic. The ball possession statistic is the building block of the computation of all the other statistics. It is to be noted that the ball possession statistic is only computed on the basis of the RSSI and ID values originating from the RFID sensors.

By contrast, the comparison of the RSSI data originating from the RFID sensors and the data from the accelerometers allows the entire playing sequence of the match to be reconstituted and a set of second-order statistics to be deduced therefrom, such as, for example, the statistics relating to passes and shots, tackles, dribbles, etc.

According to the invention, the RSSI values therefore have two essential uses. The first use is to be able to select the playing events that are useful for the overall analysis of the match (i.e. those where at least one player is near the ball). The second use is to allow most of the playing statistics to be computed by comparing the RSSI data with the data from the accelerometers in order to determine the individual playing events and to deduce therefrom all the desired playing statistics: ball possession, pass, successful/unsuccessful pass, tackle, successful/unsuccessful tackle, defensive/offensive action, shot, successful/unsuccessful shot, dribble, successful/unsuccessful dribble, etc.).

The use of the method and of the device according to the invention will now be described in further detail for obtaining examples of statistics relating to playing events within the context of playing soccer.

### Keeping the Ball:

The ball keeper is defined at the instant t as being the player who is nearest the ball at the time of an RFID reading. Thus, at a given read RFID time-stamp, the keeper of the ball is the player whose RFID sensor has the lowest RSSI strength as an absolute value.

### Ball Possession:

Being the keeper of the ball at a given time does not necessarily mean that the player is in “possession” of the ball. Indeed, it is possible that a player not in possession of the ball has been nearer the ball than the possessor of the ball for a very short period. Ball possession therefore means keeping the ball during a period corresponding to several successive RFID sensor readings.

Ball possession, expressed as time, is a variable incremented at each RFID reading time. At the initial match start time, the ball possession of each player is reset to zero. At each RFID reading time, this variable is incremented for each player according to the following three cases:
1^{st} case: the player is the keeper of the ball during the current RFID reading time and the player was the keeper of the ball during the preceding RFID reading time: the corresponding playing event is that the player simply kept the ball;
2^{nd} case: the player keeping the ball during the current RFID reading time was not the keeper of the ball during the preceding time, and is the keeper of the ball during the time following the actual RFID reading time: the corresponding playing event is that the player has just taken the ball;
3^{rd} case: the player is not the keeper of the ball during the current RFID reading time, but was the keeper of the ball during the two preceding RFID reading times, and during the reading time following the current RFID reading time: the corresponding playing event is that the player has kept the ball but, during the current RFID reading time, another player was nearer the ball than they were, without taking possession thereof.

When one of these 3 cases occurs for a player, their ball possession statistic is incremented by the time interval between the current RFID reading time and the preceding time.

### Loss of the Ball:

The loss of the ball, expressed as a number, is a variable incremented at each RFID reading time. At the initial match start time, the ball loss statistic of each player is reset to zero.

At each RFID reading time, this variable is incremented in the following cases:
1^{st} case: the player had possession of the ball during the time preceding the current RFID reading time and the RSSI data shows that a player from the opposing team took possession of the ball during the current reading time;
2^{nd} case: the player had possession of the ball during the time preceding the current RFID reading time and the RSSI data shows that they lost possession of the ball during the current reading time without any other player having taken possession of the ball (i.e. no one is in possession of the ball during the current reading time).

### Ball Recovery:

Ball recovery, expressed as a number, is a variable incremented at each RFID reading time. At the initial match start time, the ball recovery statistic of each player is reset to zero.

At each RFID (RSSI) reading time, this variable is incremented in the following two cases:
1^{st} case: the player has possession of the ball during the current RFID reading time, whereas a player from the opposing team had possession of the ball during the time preceding the current RFID reading time;
2^{nd} case: the player has possession of the ball during the current RFID reading time, whereas no player had possession during the time preceding the current RFID reading time.

### Passing and Shooting:

In order to be able to identify the passing and shooting actions, it is important to define the periods when the player keeps possession of the ball during a set of consecutive readings. These periods are called “playing periods”. A playing period is an interval made up of two RFID reading times: a start time and an end time. The player has possession of the ball between these two times. The player does not have possession of the ball before and after these times.

Two significant times are identified in a playing period:
the contact time corresponding to the last time at which the foot of the player was in contact with the ball. After this time, the RSSI strength as an absolute value is strictly increasing: the ball moves away from the RFID sensor. The contact time corresponds to the time at which the foot makes contact with the ball and possibly makes a pass or a shot;
the time of action corresponding to the last time before the contact time, such that before this time the RSSI strength as an absolute value is increasing and that after this time it is decreasing. The time of action corresponds to the start time of the playing action, i.e. the period when the foot of the player begins to descend toward the ball up until final contact.

A necessary condition to ensure that contact definitely has been made between the foot of the player and the ball at the time of the contact time is that the strength as an absolute value at this time is less than a threshold, which is called maximum contact strength threshold.

Under these conditions, it is then possible to identify a passing or a shooting action. These two actions are therefore identified by the analysis of the RFID data that is supplemented by the analysis of the accelerometer data.

The differentiation between a shooting action and a passing action initially occurs by studying the elapsed time between the last time of the playing period, i.e. the last time at which the player is still in possession of the ball, and the time of the start of the action, i.e. the previously defined time of action.

It is then possible to define two duration thresholds in order to differentiate a pass and a shot: the passing duration threshold and the shooting duration threshold:
1^{st} case: if the observed duration is less than the shooting duration threshold, then a shot is involved;
2^{nd} case: if the observed duration is greater than the passing duration threshold, then a pass is involved;
3^{rd} case: if the duration is between the shooting duration threshold and the passing duration threshold, then it is the data from the accelerometers that supplements the analysis and allows the action to be identified.

In this third case, studying the accelerometer data allows a conclusion to be drawn. To this end, the average values of the X, Y, Z data of the accelerometer (as an absolute value) are computed between the time of action and the time of contact. If the average observed acceleration values are within the interval made up of the threshold values specific to the passing action, then the action is a pass. If the observed average values are within the interval made up of the threshold values specific to the shooting action, then the action is a shot.

### Successful Pass:

The successful pass statistic, expressed as a number, is a variable incremented at each RFID reading time. At the initial match start time, the successful pass statistic of each player is reset to zero.

At each RFID reading time, this variable is incremented in the following case: a passing action is identified at the current RFID reading time AND the RSSI data shows, during the next time period, that another player from the same team has possession of the ball.

### Unsuccessful Pass:

The unsuccessful pass statistic, expressed as a number, is a variable incremented at each RFID reading time. At the initial match start time, the unsuccessful pass statistic of each player is reset to zero.

At each RFID reading time, this variable is incremented in the following cases:
1^{st} case: a passing action is identified at the current RFID reading time AND the RSSI data shows, during the next time period, that another player from the opposing team has possession of the ball;
2^{nd} case: a passing action is identified at the current RFID reading time AND the RSSI data shows, during the next time period, that no player is in possession of the ball.

### Tackle:

If two players from opposing teams are, according to their accelerometer data, in a walking or running phase at the same time and have RSSI readings, they are then tackling. By virtue of the RSSI data it is possible to know who has possession before and after this tackle. It is then possible to know whether the tackle is successful or unsuccessful.

### ADVANTAGES OF INVENTION

The invention achieves the stated aims. The new device and the new method for acquiring and processing data allows a set of playing statistics of the players to be obtained quickly and reliably, by virtue of the use of the RSSI received strength. The system is particularly simple and economical, and yet it very precisely provides a significant amount of individual or collective statistics. Furthermore, the system according to the invention is much more responsive than the known systems, since it enables a time of detection of the presence of the ball within a 50 cm radius in less than 50 ms, in order to be able to capture all the playing events up to a ball speed reaching 80 km/h.

1. A system for collecting and processing data associated with players playing a ball game, wherein the ball comprises at least one RFID transmitter in the form of a radiofrequency tag, comprising:
for each player, an active RFID radiofrequency sensor worn on every limb allowed to come into contact with the ball, said RFID sensor being configured to measure, on the basis of the strength (RSSI) of the radiofrequency signal received from the RFID transmitter, the instantaneous distance between said RFID sensor and said RFID transmitter, and an accelerometer configured to measure the instantaneous acceleration of said limb, as well as a microprocessor and a memory for time-stamping and storing the measurements originating from the RFID sensor and the accelerometer for the purpose of post-processing; and
a central processing unit provided with a program configured to read and process the data recorded in the memory units worn by the players and to deduce therefrom data representing certain physical or technical information related to the play of the players.

2. The system as claimed in claim 1, wherein each RFID sensor is configured to transmit a periodic radio signal for detecting the RFID tag of the ball, for periodically determining the RSSI value and for associating therewith a time-stamp of the detection.

3. The system as claimed in claim 1, optimized for the game of indoor soccer, comprising an anklet for each foot of the players, each anklet integrating an RFID sensor and an accelerometer, each sensor being provided with an identification number associated with a single player.

4. A method for processing data recorded by the system as claimed in claim 1, so as to generate playing statistics for the different players, comprising a step involving deducing, from the absolute value of each RSSI strength value recorded by an RFID sensor, the instantaneous distance between this RFID sensor of a player and the ball, said absolute value of the RSSI strength being lower the nearer the ball is to the RFID sensor of said player.

5. The processing method as claimed in claim 4, comprising a step involving recording each detected RSSI strength value that is less than a predefined threshold value RSSIₘₐₓ, as well as the time-stamp of its detection.

6. The processing method as claimed in claim 4, comprising a step involving recording, at regular intervals, the values originating from the accelerometers worn by each player, as well as the time-stamp corresponding to each recording and the identification (ID) of the player corresponding to each recording.

7. The processing method as claimed in claim 4, wherein, at the end of the match time, the data of the RFID sensors of all the players and the data of the accelerometers of all the players is collated and sorted in chronological order for post-processing to identify playing events and determine playing statistics.

8. The processing method as claimed in claim 7, comprising a step involving determining, on the basis of the values originating from the RFID sensors, a playing event involving keeping the ball at a given instant, with the keeper of the ball being defined as being the player whose absolute value of the RSSI strength is the lowest at the given instant.

9. The processing method as claimed in claim 7, comprising a step involving determining, on the basis of the action of keeping the ball, a playing event involving possession of the ball, with the possessor of the ball during a period being defined as being the player keeping the ball at several successive time-stamps of the data originating from the RFID sensors.

10. The processing method as claimed in claim 9, comprising a step involving determining, on the basis of the ball possession information, a ball loss statistic for each player, incremented each time that the readings of the RSSI value show that the possession of the ball has passed to a player on the opposing team.

11. The processing method as claimed in claim 9, comprising a step involving determining, on the basis of the ball possession information, a ball recovery statistic for a given player, incremented each time that the readings of the RSSI value show that the possession of the ball has passed from a player on the opposing team to said given player.

12. The processing method as claimed in claim 9, comprising a step to distinguish a shot by a player and a pass, involving measuring the elapsed time between the last time of a playing period when the player still has possession of the ball, and the time of the start of the action, and (i) if the observed duration is less than a predetermined threshold corresponding to the duration of a shot, then it involves a shot, and (ii) if the observed duration is greater than a predetermined threshold corresponding to the duration of a pass, then it involves a pass, and (iii) if the elapsed time is within the shot duration threshold and the pass duration threshold, the data of the accelerometers allows the action to be identified, with an action with an acceleration that is greater than a predetermined average value corresponding to a shot, and an action with an acceleration that is less than a predetermined average value corresponding to a pass.

13. The processing method as claimed in claim 9, comprising a step involving identifying a shot taken by a player, when, at the end of a period of possession of the ball by a player, the RSSI strength as an absolute value indicated by the RFID sensor of said player is strictly increasing, without the RSSI value of the RFID sensors of the other players indicating that another player has taken possession of the ball.

14. The processing method as claimed in claim 9, comprising a step involving identifying a successful pass by a player when, at the end of a period of possession of the ball by a player, the RSSI value shows that, at the time following said possession period, the possession of the ball has passed to another player on the same team.

15. The processing method as claimed in claim 9, comprising a step involving identifying an unsuccessful pass by a player when, at the end of a period of possession of the ball by a player, the RSSI values show that, at the time following said possession period, the possession of the ball has passed to a player on the opposing team.
